(19) United States
(12) Patent Application Publication
(10) Pub. No.: US 2020/0207200 A1
(43) Pub. Date: Jul. 2, 2020

(54) ELECTRICAL EQUIPMENT

(71) Applicant: TOYOTA JIDOSHA KABUSHIKI KAISHA, Toyota-shi (JP)

(72) Inventors: Kenshi YAMANAKA, Nukata-gun (JP); Hiroto KUSAKA, Toyota-shi (JP)

(73) Assignee: TOYOTA JIDOSHA KABUSHIKI KAISHA, Toyota-shi (JP)

(21) Appl. No.: 16/697,274

(22) Filed: Nov. 27, 2019

(30) Foreign Application Priority Data
Dec. 26, 2018 (JP) 2018-242232

(51) Int. Cl. B60K 1/04; B60K 11/02; B60L 50/51

(52) U.S. Cl. CPC B60K 1/04; B60K 2001/003; B60L 50/51; B60K 11/02

(57) ABSTRACT

Electrical equipment disclosed herein may include: a case; a partition plate provided in the case, the partition plate including a first surface, a second surface located opposite to the first surface, and a through hole; a first heat generating member attached to the first surface of the partition plate; and a second heat generating member attached to the second surface of the partition plate, wherein the first heat generating member may seal the through hole from a first surface side and the second heat generating member may seal the through hole from a second surface side, and the first heat generating member, the second heat generating member, and the through hole may configure a coolant passage in which a liquid coolant flows.

### CROSS-REFERENCE TO RELATED APPLICATION

This application claims priority to Japanese Patent Application No. 2018-242232, filed on Dec. 26, 2018, contents of which are incorporated herein by reference.

### TECHNICAL FIELD

The art disclosed herein relates to electrical equipment. Especially, it relates to electrical equipment including a case provided with a cooler.

### BACKGROUND

Various types of high voltage equipment to which a voltage exceeding 100 volts is applied are installed in an electric vehicle. Examples of the high voltage equipment include a main battery, a traction motor, and a power converter configured to convert power from the main battery to drive power for the traction motor. An electric vehicle described in International Publication No. WO 2014/030445 is provided with a power distribution module (hereinbelow termed “PDM”) configured to distribute power from a main battery to a plurality of high voltage equipment.

High voltage equipment generate a large amount of heat. The PDM of International Publication No. WO 2014/030445 is configured to cool components by intaking external air into a case. Further, Japanese Patent Application Publication No. H11-266508 describes electrical equipment in which a cooler is provided in a case that accommodates heat generating components. The electrical equipment of Japanese Patent Application Publication No. H11-266508 is provided with a heat radiator to which a charger and a converter are attached, and a fan configured to supply cooling air to the heat radiator.

### SUMMARY

The electrical equipment of International Publication No. WO 2014/030445 and the electrical equipment of Japanese Patent Application Publication No. H11-266508 cool the components inside their cases by air. In a case where components generate a large amount of heat, a cooling method using a liquid coolant is employed instead of air cooling. However, providing a coolant passage (that is, a cooler) in a case results in a complicated shape of the case, which causes increase in cost. The disclosure herein provides art that realizes electrical equipment that includes a case provided with a coolant passage (cooler) at low cost.

Electrical equipment disclosed herein may comprise: a case; a partition plate provided in the case, the partition plate comprising a first surface, a second surface located opposite to the first surface, and a through hole; a first heat generating member attached to the first surface of the partition plate; and a second heat generating member attached to the second surface of the partition plate, wherein the first heat generating member may seal the through hole from a first surface side and the second heat generating member may seal the through hole from a second surface side, and the first heat generating member, the second heat generating member, and the through hole may configure a coolant passage in which a liquid coolant flows.

Details and further improvements of the art disclosed herein will be described in the following DETAILED DESCRIPTION.

### BRIEF DESCRIPTION OF DRAWINGS

FIG. 1 is an exploded perspective view of electrical equipment (power unit) of an embodiment (without covers).

FIG. 2 is a perspective view of a case as seen from obliquely below.

FIG. 3 is a bottom view of the case.

FIG. 4 is a plan view of the power unit (without the covers).

FIG. 5 is a cross-sectional view of the power unit sectioned along a line V-V of FIG. 4 (without the covers).

FIG. 6 is a cross-sectional view of the power unit (with components thereof disassembled).

### DETAILED DESCRIPTION

In an embodiment of the present technology, electrical equipment may comprise: a case; a partition plate provided in the case, the partition plate comprising a first surface, a second surface located opposite to the first surface, and a through hole; a first heat generating member attached to the first surface of the partition plate; and a second heat generating member attached to the second surface of the partition plate, wherein the first heat generating member may seal the through hole from a first surface side and the second heat generating member may seal the through hole from a second surface side, and the first heat generating member, the second heat generating member, and the through hole may configure a coolant passage in which a liquid coolant flows.

The electrical equipment disclosed herein uses surfaces of the respective heat generating members accommodated in the case as inner walls of the coolant passage in which the liquid coolant flows. Due to this, a structure of the case is simplified, and manufacturing cost can thereby be reduced.

In an embodiment of the present technology, fins may be provided on a surface of at least one of the first heat generating member and the second heat generating member, and the surface may face the through hole.

In an embodiment of the present technology, the at least one of the first heat generating member and the second heat generating member may comprise: a heat generating member body; a base plate attached to the heat generating member body and the partition plate; and the fins provided on a surface of the base plate that faces the through hole.

In an embodiment of the present technology, the first surface of the partition plate may include a recess that communicates with the through hole, and the first heat generating member may seal the recess.

In an embodiment of the present technology, the electrical equipment may further comprise a third heat generating member attached to the second surface of the partition plate in an area opposite to the recess of the first surface.

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved electrical equipment, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### Embodiments

Electrical equipment of an embodiment will be described with reference to the drawings. The electrical equipment of the embodiment is a power unit 2 installed in an electric vehicle. The power unit 2 is connected to a main battery, an auxiliary battery, a power converter, a charging inlet, and the like, and is configured to relay power therebetween. The power converter is a device configured to convert power from the main battery to drive power for a traction motor.

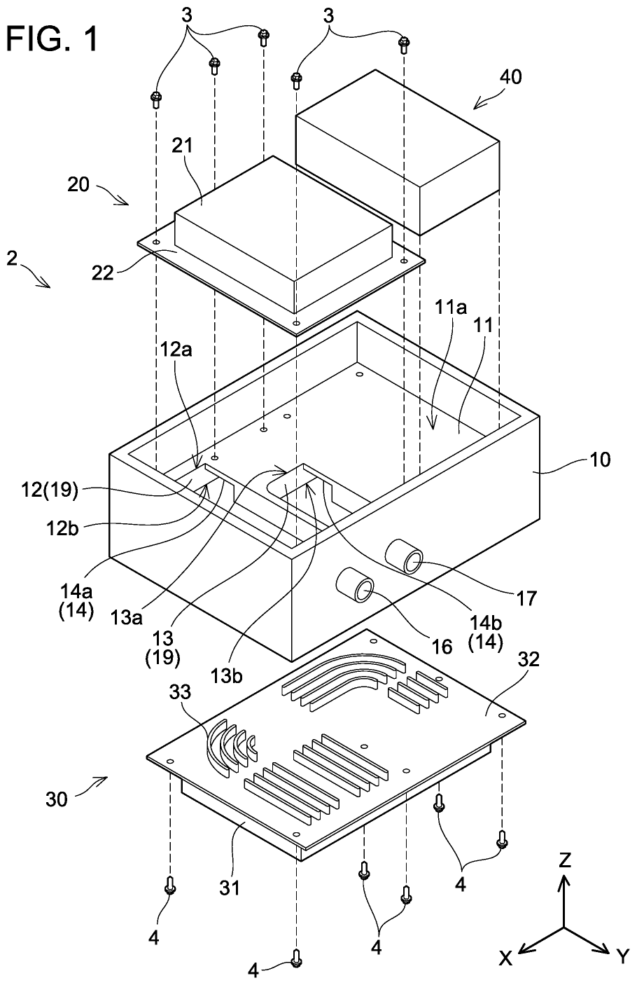

FIG. 1 shows an exploded perspective view of the power unit 2. FIG. 1 omits depiction of upper and lower covers that cover openings of a case 10 of the power unit 2. For convenience of explanation, in a coordinate system of the drawings, a +Z direction is defined as “upward” and a -Z direction is defined as “downward”.

The power unit 2 includes a DC/DC converter 20, an AC charger 30, and a DC relay 40. These components are accommodated in the case 10. The power unit 2 further includes various other components than the aforementioned, however, depiction of these other components is omitted. The case 10 includes a plurality of connectors, however, depiction thereof is also omitted.

The DC/DC converter 20 is a device configured to step down a voltage of the main battery and supply the same to the auxiliary battery. The AC charger 30 is a device configured to convert AC power inputted from an external AC power supply to DC power and supply the same to the main battery. The DC relay 40 is a switch connected between the main battery and a DC inlet to which an external DC power supply can be connected. The DC/DC converter 20, the AC charger 30, and the DC relay 40 each generate a large amount of heat because large current flows therein. The power unit 2 can cool the DC/DC converter 20, the AC charger 30, and the DC relay 40 by a cooler (coolant passage) provided in the case 10.

The case 10 is provided with a partition plate 11 that divides an internal space of the case into two. The DC/DC converter 20 and the DC relay 40 are accommodated in an upper space (which is the space on an upper surface 11a side of the partition plate 11) in the case 10. The AC charger 30 is accommodated in a lower space (which is the space on a lower surface 11b side of the partition plate 11) in the case 10.

The DC/DC converter 20 is attached to the upper surface 11a of the partition plate 11 by a plurality of bolts 3. The DC/DC converter 20 is configured of a DC/DC converter body 21 that accommodates electric components therein and a base plate 22 that is attached to the DC/DC converter body 21. The base plate 22 is attached to the partition plate 11 by the bolts 3. Although details will be described later, fins are provided on a surface of the base plate 22 that faces the partition plate 11. The base plate 22 and the fins provided on the base plate 22 are constituted of aluminum with high heat conductivity.

The DC relay 40 is also attached to the upper surface 11a of the partition plate 11. Depiction of bolts that attach the DC relay 40 is omitted.

The AC charger 30 is attached to the lower surface 11b of the partition plate 11 by a plurality of bolts 4. The AC charger 30 is configured of an AC charger body 31 that accommodates electric components therein and a base plate 32 that is attached to the AC charger body 31. The base plate 32 is attached to the partition plate 11 by the bolts 4. Fins 33 are provided on a surface of the base plate 32 that faces the partition plate 11. The fins 33 will be described later.

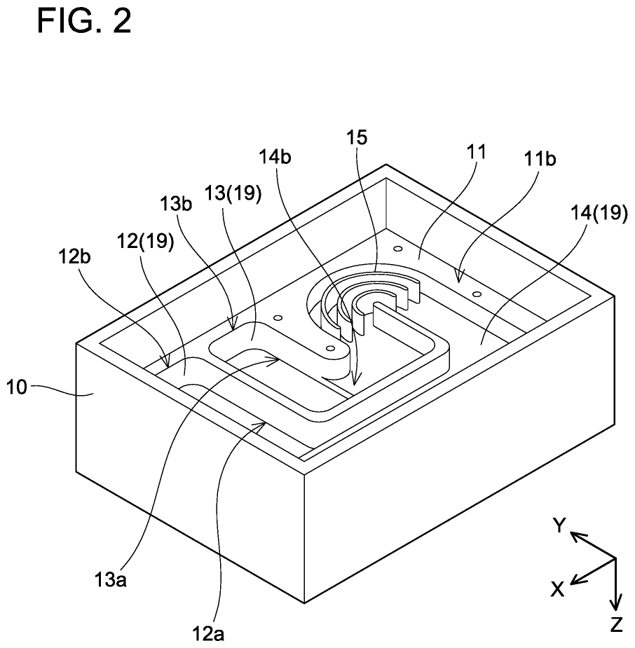

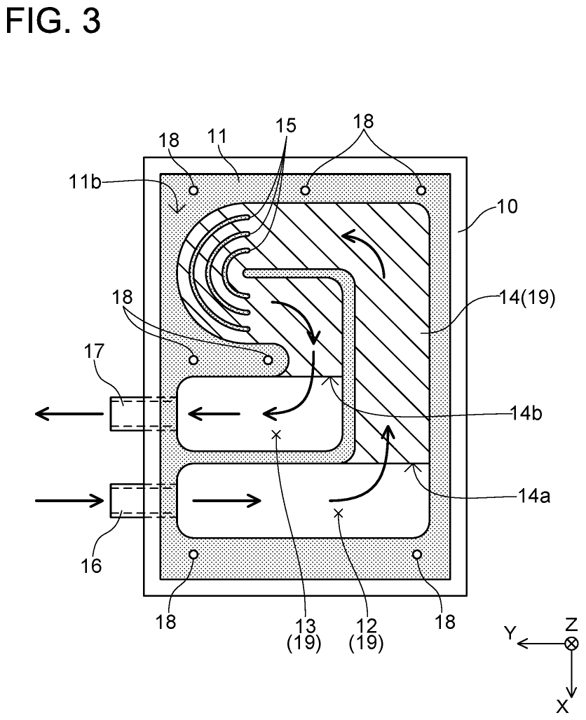

The partition plate 11 of the case 10 will be described. FIG. 2 shows a perspective view of the case 10 as seen from obliquely below. FIG. 3 shows a bottom view of the case 10. The partition plate 11 of the case 10 is provided with two through holes 12, 13. As shown in FIG. 2, a recess 14 is provided in the lower surface 11b of the partition plate 11. In FIG. 3, the lower surface 11b of the partition plate 11 is indicated in gray and a bottom surface of the recess 14 is indicated with oblique hatching lines, to aid comprehension. White areas surrounded by the gray portion correspond to the through holes 12, 13.

A part of a side surface of the recess 14 is cut up to the through hole 12, thus the recess 14 communicates with the through hole 12. A portion of the recess 14 where the recess 14 communicates with the through hole 12 will hereinbelow be termed a communicating portion 14a. Further, another part of the side surface of the recess 14 is cut up to the through hole 13, thus the recess 14 also communicates with the through hole 13. A portion of the recess 14 where the recess 14 communicates with the through hole 13 will hereinbelow be termed a communicating portion 14b.

As described above, the DC/DC converter 20 (the base plate 22) is attached to the upper surface 11a of the partition plate 11. The base plate 22 is attached to the upper surface 11a such that the base plate 22 covers one opening 12a of the through hole 12 and one opening 13a of the through hole 13. In other words, the base plate 22 is attached to the upper surface 11a such that the base plate 22 closes the through holes 12, 13. Although not shown, a gasket which surrounds the through holes 12, 13 is disposed between the base plate 22 and the partition wall 11. The gasket closes spaces between the openings 12a, 13a of the through holes 12, 13 and the base plate 22.

Further, as described above, the AC charger 30 (the base plate 32) is attached to the lower surface 11b of the partition plate 11. Reference sign 18 in FIG. 3 shows bolt holes in which the bolts 4 for attaching the base plate 32 are fastened. The base plate 32 is attached to the lower surface 11b such that the base plate 32 covers the other opening 12b of the through hole 12, the other opening 13b of the through hole 13 and the recess 14. In other words, the base plate 32 is attached to the lower surface 11b such that the base plate 32 closes the through holes 12, 13 and the recess 14. Although not shown, another gasket which surrounds the through holes 12, 13 and the recess 14 is disposed between the base plate 32 and the partition wall 11. This gasket closes spaces between the openings 12b, 13b of the through holes 12, 13 and the base plate 32. Further, this gasket closes space between the recess 14 and the base plate 32.

The through holes 12, 13 are closed by the base plate 22 of the DC/DC converter 20 and the base plate 32 of the AC charger 30 in a state of being interposed therebetween. Further, the recess 14 is closed by the base plate 32. The recess 14 communicates with the through holes 12, 13, by which the through holes 12, 13 and the recess 14 define one closed space. The closed space configures a coolant passage 19 in which a liquid coolant flows. The base plates 22, 32 correspond to inner walls that configure the coolant passage. The base plate 22 of the DC/DC converter 20 and the base plate 32 of the AC charger 30 face each other with the through holes 12, 13 interposed therebetween. Attaching the base plates 22, 32 to the partition plate 11 closes the through holes 12, 13, and thus forms the coolant passage 19. In other words, spaces surrounded by the base plates 22, 32 and inner surfaces of the through holes 12, 13 are the coolant passage 19 in which the coolant flows. A space surrounded by the base plate 32 and the recess 14 communicates with the through holes 12, 13, and also is a part of the coolant passage 19.

The case 10 is provided with a supply pipe 16 that communicates outside of the case with the through hole 12 and a discharge pipe 17 that communicates the outside of the case with the through hole 13. A coolant circulation device, which is not shown, is connected to the supply pipe 16 and the discharge pipe 17. Bold arrows in FIG. 3 schematically show a flow of the coolant. The coolant supplied through the supply pipe 16 flows into the through hole 12. The coolant flows from the through hole 12 to the recess 14 through the communicating portion 14a. The coolant then flows from the recess 14 to the through hole 13 through the communicating portion 14b. The coolant flows from the through hole 13 through the discharge pipe 17, and returns to the coolant circulation device. Liquid is used as the coolant. The coolant may, for example, be water or anti-freeze solution.

As shown in FIG. 1, the plurality of fins 33 is provided on the surface of the base plate 32 of the AC charger 30 that faces the partition plate 11. More specifically, the base plate 32 is provided with the plurality of fins 33 at areas thereof that face the through holes 12, 13 and the recess 14. The base plate 32 and the fins 33 are constituted of aluminum with high heat conductivity. In a state where the AC charger 30 is attached to the case 10, the fins 33 are located within the through holes 12, 13 and the recess 14. That is, the fins 33 are disposed in the coolant passage 19. Heat of the AC charger body 31 is absorbed by the coolant via the base plate 32 corresponding to an inner wall of the coolant passage 19 and the fins 33 exposed in the coolant passage 19.

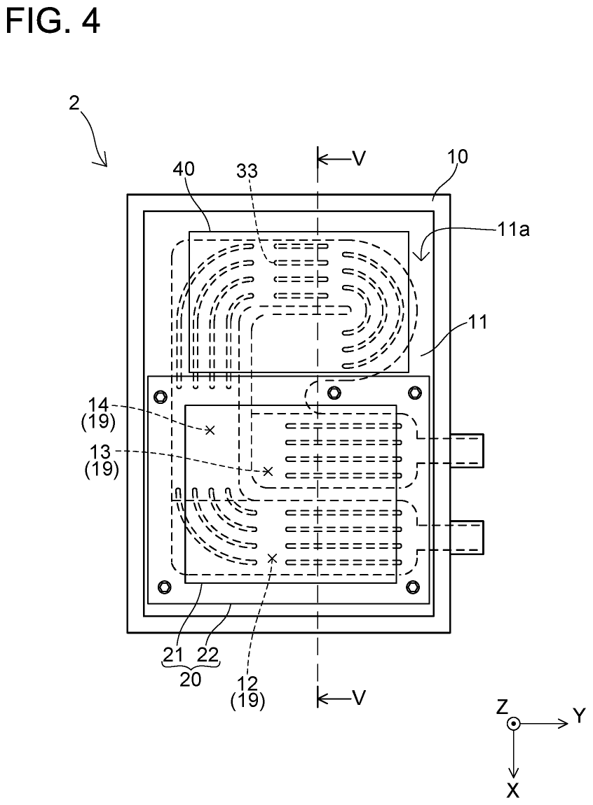

A plurality of fins 15 is provided on the partition plate 11 as well (FIG. 2). The fins 15 are provided on the bottom surface of the recess 14 of the partition plate 11. FIG. 4 shows a plan view of the power unit 2. FIG. 4 also omits the depiction of the covers closing the case 10. FIG. 4 is the plan view of the power unit 2 as seen from the above. In FIG. 4, the through holes 12, 13, the recess 14, and the fins 15 of the partition plate 11 and the fins 33 of the AC charger 30 are shown with broken lines. Fins are provided also on the base plate 22 of the DC/DC converter 20, however, depiction of the fins of the base plate 22 is omitted in FIG. 4.

The DC relay 40 is attached to the upper surface of the partition plate 11 that is opposite to the recess 14. That is, in the plan view of FIG. 4, the fins 15 provided on the partition plate 11 are arranged to overlap with the DC relay 40. FIG. 4 corresponds to a diagram seeing the power unit 2 along a normal direction of the partition plate 11. That is, the DC relay 40 is attached to the upper surface of the partition plate 11 in an area thereof opposite to the recess 14, and arranged at the position overlapping with the fins 15 as seen along the normal direction of the partition plate 11.

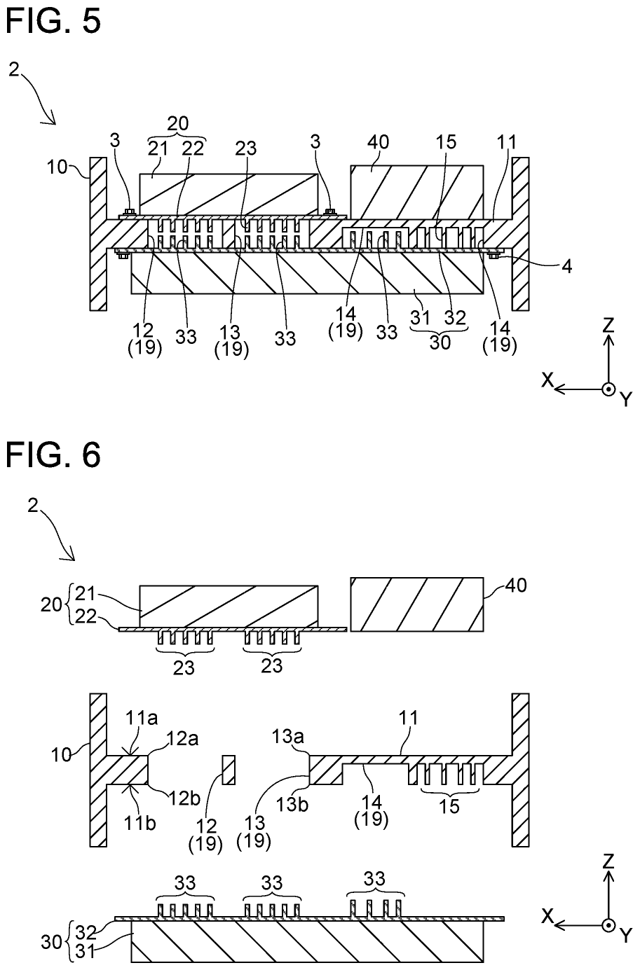

FIG. 5 shows a cross-sectional view along a line V-V of FIG. 4. The case 10 is open at both of its upper and lower sides, which are respectively closed by the upper and lower covers, however, FIG. 5 also omits the depiction of the covers.

The base plate 22 of the DC/DC converter 20 is also provided with the plurality of fins 23 at positions facing the through holes 12, 13. The fins 33 of the base plate 32 of the AC charger 30 are also disposed to face the through holes 12, 13. The base plate 32 is provided with a large number of the fins 33, and some of the fins are disposed to face the recess 14.

As shown in FIG. 5, the fins 23 of the base plate 22 are arranged to face the fins 33 of the base plate 32 inside the through holes 12, 13. Heat of the DC/DC converter body 21 is absorbed by the coolant flowing through the coolant passage 19 via the base plate 22 and the fins 23. Further, as described above, the heat of the AC charger body 31 is absorbed by the coolant flowing through the coolant passage 19 via the base plate 32 and the fins 33.

As shown in FIGS. 4 and 5, the DC relay 40 is attached to the partition plate 11 on the opposite side to the recess 14, and the recess 14 has the fins 15 provided to overlap with the DC relay 40. Heat from the DC relay 40 is absorbed by the coolant via the fins 15 and a portion of the partition plate 11 corresponding to a base plate of the recess 14.

FIG. 6 shows an exploded cross-sectional view with the DC/DC converter 20, the AC charger 30, and the DC relay 40 detached from the case 10. As described above, the base plate 22 of the DC/DC converter 20 is attached to the upper surface 11a of the partition plate 11 such that it seals the one opening 12a of the through hole 12 and the one opening 13a of the through hole 13. Further, the base plate 32 of the AC charger 30 is attached to the lower surface 11b of the partition plate 11 such that it seals the other opening 12b of the through hole 12, the other opening 13b of the through hole 13, and the recess 14. The coolant passage 19 is formed by the base plates 22, 32 sealing the through holes 12, 13 and the recess 14.

As shown well in FIG. 6, the partition plate 11 of the case 10 is simply provided with the simple through holes 12, 13 and the simple recess 14, thus a shape thereof is relatively simple. The art described in the embodiment can realize the power unit 2 in which the coolant passage 19 is included in the case 10 at relatively low cost.

Some of the features of the power unit 2 of the embodiment will be listed below.

(1) The power unit 2 includes the case 10 including the partition plate 11, the DC/DC converter 20, and the AC charger 30. Both the DC/DC converter 20 and the AC charger 30 generate a large amount of heat. The DC/DC converter 20 is attached to one surface (the upper surface 11a) of the partition plate 11. The AC charger 30 is attached to another surface (the lower surface 11b) of the partition plate 11. The partition plate 11 is provided with the through holes 12, 13. The DC/DC converter 20 and the AC charger 30 face each other with the through holes 12, 13 interposed therebetween. The DC/DC converter 20 is attached to the upper surface 11a of the partition plate 11 such that it seals the one opening 12a of the through hole 12 and the one opening 13a of the through hole 13. The AC charger 30 is attached to the lower surface 11b of the partition plate 11 such that it seals the other opening 12b of the through hole 12 and the other opening 13b of the through hole 13. The coolant passage 19 in which the liquid coolant flows is configured by the DC/DC converter 20, the AC charger 30, and the through holes 12, 13. A shape of the partition plate 11 is simplified due to the DC/DC converter 20 and the AC charger 30 serving as parts of the inner walls of the coolant passage 19. Manufacturing cost of the case 10 is thereby reduced.

(2) Both the DC/DC converter 20 and the AC charger 30 are provided with the fins 23, 33 respectively, on their surfaces facing the through holes 12, 13. The fins 23, 33 are exposed in the coolant passage 19. By providing the fins 23, 33, cooling efficiency for the DC/DC converter body 21 and the AC charger body 31 is improved. The fins may be provided on both the DC/DC converter 20 and the AC charger 30, or may be provided on either one of them.

The DC/DC converter 20 includes the DC/DC converter body 21 and the base plate 22 which is attached to the DC/DC converter body 21 and is attached to the partition plate 11. The AC charger 30 includes the AC charger body 31 and the base plate 32 which is attached to the AC charger body 31 and is attached to the partition plate 11. When the DC/DC converter body 21 (or the AC charger body 31) is replaced, it can be replaced altogether with the base plate 22 (or altogether with the base plate 32), which facilitates the replacement work.

The partition plate 11 is provided with the recess 14 that communicates with the through holes 12, 13. The AC charger 30 (the base plate 32) seals the recess 14. An entirety of the coolant passage does not necessarily be configured by through holes, and a recess may be provided in the partition plate 11 to configure the coolant passage. The DC relay 40, which is another heat generating member, may be attached to the upper surface of the partition plate 11 in an area thereof opposite to the recess 14.

Other features related to the art described in the embodiment will be listed. The fins 15 are provided in a part of an area of the recess 14 of the partition plate 11, and the fins 33 of the AC charger 30 are located in the remaining part of the area. The fins 15 contribute to cooling of the DC relay 40 which is attached to the upper surface of the partition plate 11 in the area thereof opposite to the recess 14. The fins 33 contribute to cooling of the AC charger 30. A ratio of the fins 15 and the fins 33 may be determined based on a ratio of desired cooling performance for the DC relay 40 and desired cooling performance for the AC charger 30.

The case 10 is provided with the supply pipe 16 communicating the outside of the case with the through hole 12 and the discharge pipe 17 communicating the outside of the case with the through hole 13. Both the through hole 12 and the through hole 13 communicate with the recess 14. The coolant circulation device (not shown) for circulating the liquid coolant is connected to the supply pipe 16 and the discharge pipe 17. The coolant supplied from the coolant circulation device flows through the supply pipe 16 and enters the coolant passage 19. The coolant that has passed through the coolant passage 19 flows through the discharge pipe 17 and is returned to the coolant circulation device.

The AC charger 30 is an example of a first heat generating member and the DC/DC converter 20 is an example of a second heat generating member. The DC relay 40 is an example of a third heat generating member. The art disclosed herein may be applied to heat generating members other than an AC charger, a DC/DC converter, and a DC relay. Further, the art disclosed herein may be applied to electrical equipment other than a power unit.

What is claimed is:

1. Electrical equipment comprising:
a case;
a partition plate provided in the case, the partition plate comprising a first surface, a second surface located opposite to the first surface, and a through hole;
a first heat generating member attached to the first surface of the partition plate; and
a second heat generating member attached to the second surface of the partition plate,
wherein
the first heat generating member seals the through hole from a first surface side and the second heat generating member seals the through hole from a second surface side, and
the first heat generating member, the second heat generating member, and the through hole configure a coolant passage in which a liquid coolant flows.

2. The electrical equipment according to claim 1, wherein fins are provided on a surface of at least one of the first heat generating member and the second heat generating member, and the surface faces the through hole.

3. The electrical equipment according to claim 2, wherein
the at least one of the first heat generating member and the second heat generating member comprises:
a heat generating member body;
a base plate attached to the heat generating member body and the partition plate; and
the fins are provided on a surface of the base plate that faces the through hole.

4. The electrical equipment according to claim 1, wherein
the first surface of the partition plate includes a recess that communicates with the through hole, and
the first heat generating member seals the recess.

5. The electrical equipment according to claim 4, further comprising:
a third heat generating member attached to the second surface of the partition plate in an area opposite to the recess of the first surface.
